(19) United States
(12) Patent Application Publication
(10) Pub. No.: US 2023/0061871 A1
(43) Pub. Date: Mar. 2, 2023

(54) STEAM OVEN STEAM GENERATOR WITH HEATER CONTROL

(71) Applicant: ILLINOIS TOOL WORKS INC., Glenview, IL (US)

(72) Inventors: Adam J. KARABIN, Beavercreek, OH (US); Eric G. DEAN, Troy, OH (US); Jeffrey L. FROCK, Troy, OH (US)

(21) Appl. No.: 17/883,091

(22) Filed: Aug. 8, 2022

Related U.S. Application Data
(60) Provisional application No. 63/239,996, filed on Sep. 2, 2021.

(51) Int. Cl. F24H 15/248; F24C 15/32; A47J 27/04; A47J 36/32

(52) U.S. Cl. CPC F24H 15/248; F24C 15/32; A47J 27/04; A47J 36/32; A47J 2027/043

(57) ABSTRACT

A steam cooking system includes a steam cooking chamber and a steam generator plumbed to deliver steam to the steam cooking chamber. The steam generator includes a tank structure providing a heating chamber for holding water, a heater associated with the tank structure for heating water within the heating chamber so as to generate steam, at least one water level sensor associated with the tank, a fill line for selectively adding water to the tank, and a controller configured to control the heater and the fill line. The controller is configured to control a power level of the heater based at least in part upon a water level in the tank as indicated by the at least one water level sensor, so as to increase steam generator temperature prior to water add.

### TECHNICAL FIELD

This application relates generally to steam oven steam generators incorporating a heater control that limits peak power consumption.

### BACKGROUND

Steam generators are used in a variety of applications such as steam cooking systems in which the steam is supplied to a steam cooking cavity. Many such steam generators are used in high volume situations. A typical steam generator includes a heating chamber (e.g., within a tank) with an associated heating element (e.g., electric heating element) that is used to heat water within the tank. As steam is produced and exits the tank (e.g., for delivery to a steam oven cooking chamber), water is added back into the tank. By way of example, U.S. Patent Publication No. US2019/0282020 describes an exemplary steam oven and steam generator, and such publication is incorporated herein by reference in its entirety.

Typically, the heating element is energized at a variable power level to maintain a set water temperature within the steam generator (e.g., at or above 212° F.) and water level sensors are used to determine when to add water to the tank (e.g., when the water level reaches a low level limit) and when to stop adding water to the tank (e.g., when the water level reaches a high level limit). When the water level reaches the low limit level and water starts to be added, the steam generator temperature drops rapidly, causing the temperature control to rapidly jump to full power level in attempt to bring the water temperature back up. Operating the steam generator heating element at its peak power level is undesired due to the impact on peak load time of the facility in which the steam oven is operating, resulting in increased utility bills for the facility.

It would be desirable to provide a steam oven steam generator with a heater control with reduced peak power consumption.

### SUMMARY

In one aspect, a steam cooker includes a steam cooking chamber and a steam generator external of the steam cooking chamber and plumbed to deliver steam from a steam outlet of the steam generator to a steam inlet of the steam cooking chamber. The steam generator includes a tank structure providing a heating chamber for holding water, an electric heating system associated with the tank structure for heating water within the heating chamber so as to generate steam, a fill line for selectively adding water to the tank; and a controller configured to control the electric heating system and the fill line. The controller is configured to increase a power level of the electric heating system, based upon a water level in the tank and prior to controlling the fill line to add water to the tank, so as to increase steam generator temperature prior to water add.

In another aspect, a steam cooking system includes a steam cooking chamber and a steam generator plumbed to deliver steam to the steam cooking chamber. The steam generator includes a tank structure providing a heating chamber for holding water, a heater associated with the tank structure for heating water within the heating chamber so as to generate steam, at least one water level sensor associated with the tank, a fill line for selectively adding water to the tank, and a controller configured to control the heater and the fill line. The controller is configured to control a power level of the heater based at least in part upon a water level in the tank as indicated by the at least one water level sensor, so as to increase steam generator temperature prior to water add.

In a further aspect, a steam cooking system includes a steam cooking chamber and a steam generator plumbed to deliver steam to the steam cooking chamber. The steam generator includes a tank structure providing a heating chamber for holding water, a heater associated with the tank structure for heating water within the heating chamber so as to generate steam, at least one water level sensor associated with the tank, a temperature sensor, a fill line, and a controller configured to control the heater. The controller is configured to control a power level of the heater based upon both a temperature indicated by the temperature sensor and a water level indicated by the at least one water level sensor, so as to increase steam generator temperature prior to water add.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic view of a steam generator;

FIG. 2 is a flow chart of exemplary heater power level control;

FIG. 3 is a flow chart of another exemplary heater power level control;

FIG. 4 is a graph showing temperature, water level and power consumption for the steam generator controller according to FIG. 3;

FIG. 5 is a graph showing temperature, water level and power consumption for a steam generator controlled according to the prior art.

### DETAILED DESCRIPTION

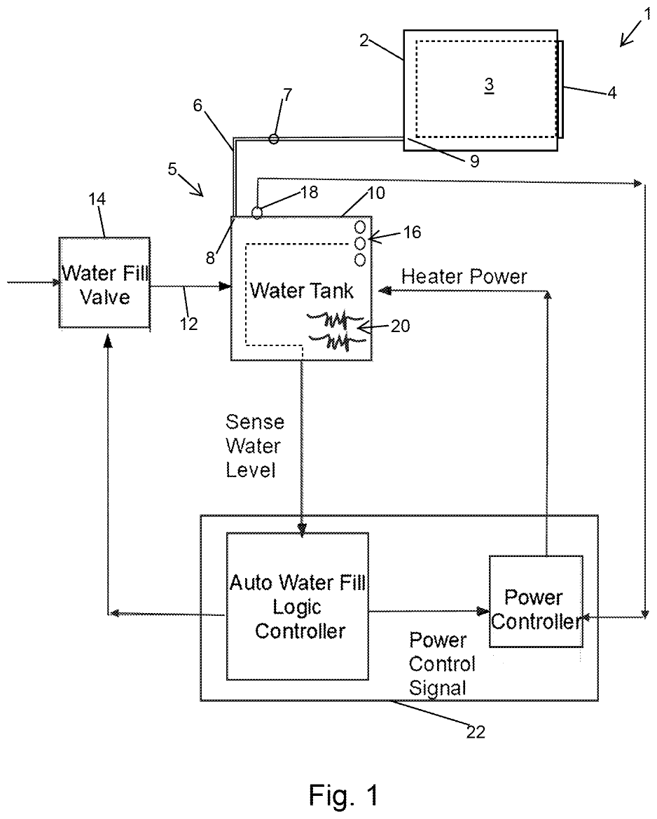

Referring to FIG. 1, a steam cooking system 1 includes a steam oven 2 defining a steam cooking chamber 3 in which food can be cooked. The chamber 3 is accessible via a door 4 that is movable between open and closed conditions relative to the chamber 3. A steam generator 5, is located external of the steam cooking chamber 3, and is plumbed (e.g., via line 6, which may include control valve 7) to deliver steam from a steam outlet 8 of the steam generator 5 to a steam inlet 9 of the steam cooking chamber 3.

The steam generator 5 includes a tank 10 with an associated fill line 12 and water fill valve 14. One or more sensor(s) 16 are located to detect the water level in the tank. A temperature sensor 18 is provided, and one or more electrical heater(s) 20 are located for heating water in the tank (e.g., submerged with the water in the tank). A controller 22 is configured to control both a state of the water fill valve 14 and power level of the electrical heater(s) 20 of the tank. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof.

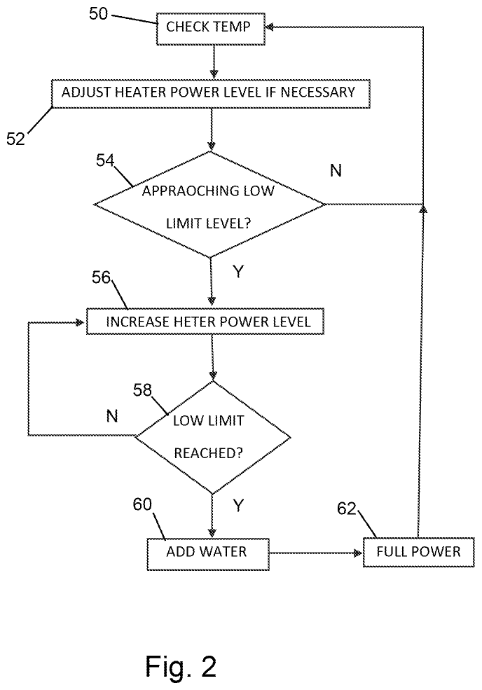

The controller 22 is configured to operate the heater(s) 20 such that the power level is increased prior to adding water to the tank, even though the typical temperature-based control algorithm does not call for such a power level increase. The flow chart of FIG. 2 is representative of one such control scheme. As suggested by the loop of steps 50, 52 and 54, initially the heater power level is controlled based upon temperature (e.g., to maintain some set temperature in the tank 10). However, when the water level in the tank 10 begins to approach the low limit that will trigger addition of water (e.g. as indicated by the sensor(s) 16), the power level of the heater(s) 20 is gradually increased, per the loop of steps 56 and 58, until water level actually falls to the low limit, at which point water is added per step 60, the heaters are set to full power per step 62 and heater power control then returns to a temperature based control per the loop of steps 50, 52 and 54. An intermediate water level sensor 16, which indicates a water level between the low limit for fill and the high limit for turning off fill, can be provided for detecting that the water level is approaching the low limit.

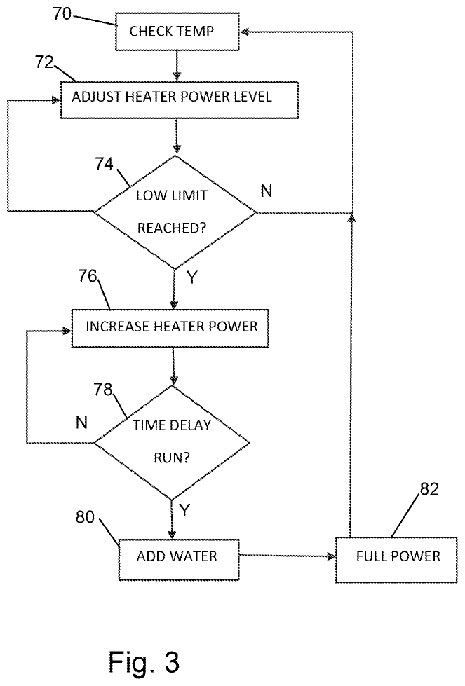

In an alternative configuration, per FIG. 3, heater power level is controlled based upon temperature per the loop pf steps 70, 72 and 74. Once the water level in the tank falls to the low limit level, the power level of the heaters is gradually increased per the loop of steps 76 and 78, until a time delay has run per step 78, at which point water is added per step 80, the heaters are set to full power per step 82 and heater power control returns to a temperature based control per the loop of steps 70, 72 and 74. In one implementation, the temperature sensor 18 detects temperature in the steam generator, or along a path from the steam generator to the steam cooking cavity. In another implementation, the sensor 18 detects a temperature within a steam vent pipe from the steam cooking chamber.

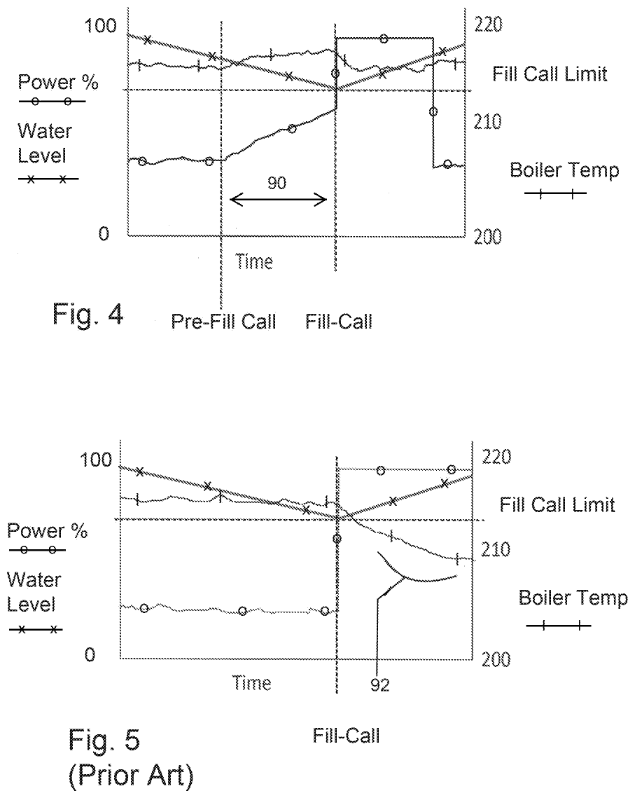

As suggested in FIG. 4, when the heater power level is gradually increased prior to the addition of water to fill the tank, per the time period 90 between the Pre-Fill Call and the Fill-Call, the steam generator temperature remains fairly consistent once water begins to fill the tank, reducing or eliminating loss of boil. By contrast, as suggested in FIG. 5, where the heater power level is not increase prior to tank filling, the steam generator temperature drops significantly, resulting in loss of boil in region 92. In addition, the duration of operation of the heaters at peak power level is significantly reduced in the inventive system represented by FIG. 4 because, by preheating the steam generator prior to the water add, the temperature drop caused by the water add is reduced.

In both of the control embodiments contemplated by FIGS. 2 and 3, during steam production, the controller is configured to control a power level of the heater based at least in part upon a water level in the tank, while maintaining the power level below a full power level of the heater. Moreover, in both embodiments, during steam production, the controller is configured to increase a power level of the heating system/heater, based upon a water level in the tank and prior to controlling the fill line to add water to the tank, so as to increase steam generator temperature prior to water add.

Likewise, in both control embodiments, the controller is configured to control a power level of the heater based upon both a temperature indicated by the temperature sensor and a water level indicated by the at least one water level sensor, so as to increase steam generator temperature prior to water add. In particular, the controller is configured to control the power level of the heater based upon the temperature indicated by the temperature sensor so as to maintain the temperature at a preset temperature level (e.g., a range around boiling), until the water level indicated by the at least one water level sensor reaches a threshold low level (e.g., the intermediate level in the case of 2 or the low limit level in the case of FIG. 3), at which point the controller begins to increase the power level of the heater without regard to the preset temperature level, while maintaining the power level below a full power level of the heater.

It is to be clearly understood that the above description is intended by way of illustration and example only, is not intended to be taken by way of limitation, and that other changes and modifications are possible. For example, the advantageous heater control scheme for the steam generator could be implemented in cooking devices that include other cooking technologies as well (e.g., combination ovens). All such devices, whether steam only or steam in combination with other cooking technologies, are deemed steam cookers or steam cooking systems, as those terms are used herein.

What is claimed is:

1. A steam cooker, comprising:
a steam cooking chamber;
a steam generator external of the steam cooking chamber and plumbed to deliver steam from a steam outlet of the steam generator to a steam inlet of the steam cooking chamber, the steam generator including:
a tank structure providing a heating chamber for holding water;
an electric heating system associated with the tank structure for heating water within the heating chamber so as to generate steam;
a fill line for selectively adding water to the tank; and
a controller configured to control the electric heating system and the fill line, wherein the controller is configured to increase a power level of the electric heating system, based upon a water level in the tank and prior to controlling the fill line to add water to the tank, so as to increase steam generator temperature prior to water add.

2. The steam cooker of claim 1, wherein:
the tank includes a low limit level water level sensor;
the fill line includes a water fill valve;
the controller is configured such that, when the low limit water level sensor indicates that a water level in the tank has fallen to a low limit level, the power level of the electric heating system is increased without reaching a full power level associated with the electric heating system and, after a time period, the water fill valve is then opened to add water to the tank.

3. The steam cooker of claim 2, wherein the controller is configured such that the power level of the electric heating system is gradually increased until the water valve is opened.

4. The steam cooker of claim 3, wherein the controller is configured such that the power level of the electric heating system is increased to the full power level when the water fill valve is opened.

5. The steam cooker of claim 1, wherein:
the tank includes a level sensor arrangement for indicating a low limit level of water in the tank and for indicating an intermediate level of water in the tank that is between the low limit level of water in the tank and a high limit level of water in the tank;
the fill line includes a fill valve;
the controller is configured such that, when the level sensor arrangement indicates that a water level in the tank has fallen to the intermediate level, the power level of the electric heating system is increased without reaching a full power level associated with the electric heating system; and
after the level sensor arrangement indicates that the water level in the tank has fallen to the low limit level, the water fill valve is opened to add water to the tank.

6. The steam cooker of claim 5, wherein the level sensor arrangement comprises a first level sensor for indicating the low limit level and a second level sensor for indicating the intermediate level.

7. The steam cooker of claim 5, wherein the controller is configured such that the power level of the electric heating element is gradually increased until the first level sensor indicated the water level in the tank has fallen to the lower limit level.

8. The steam cooker of claim 7, wherein the controller is configured such that the power level of the electric heating system is increased to the full power level when the water fill valve is opened.

9. A steam cooking system, comprising:
a steam cooking chamber;
a steam generator plumbed to deliver steam to the steam cooking chamber, the steam generator including:
a tank structure providing a heating chamber for holding water;
a heater associated with the tank structure for heating water within the heating chamber so as to generate steam;
at least one water level sensor associated with the tank;
a fill line for selectively adding water to the tank;
a controller configured to control the heater and the fill line, wherein the controller is configured to control a power level of the heater based at least in part upon a water level in the tank as indicated by the at least one water level sensor, so as to increase steam generator temperature prior to water add.

10. The steam cooking system of claim 9, wherein:
the fill line includes a water fill valve;
the controller is configured such that, when the at least one water level sensor indicates that a water level in the tank has fallen to a low limit level, the power level of the heater is increased without reaching a full power level associated with the heater and, thereafter, the water fill valve is opened to add water to the tank and the power level of the heater is increased to the full power level.

11. The steam cooking system of claim 10, wherein the controller is configured such that the power level of the heater is gradually increased before the water valve is opened.

12. The steam cooking system of claim 9, wherein:
the at least one water level sensor is configured for indicating a low limit level of water in the tank and for indicating an intermediate level of water in the tank that is between the low limit level of water in the tank and a high limit level of water in the tank;
the fill line includes a fill valve;
the controller is configured such that, when the at least one water level sensor indicates that a water level in the tank has fallen to the intermediate level, the power level of the heater is increased without reaching a full power level associated with the heater; and
after the level sensor arrangement indicates that the water level in the tank has fallen to the low limit level, the water fill valve is opened to add water to the tank and the power level of the heater is increased to the full power level.

13. The steam cooking system of claim 12, wherein the at least one water level sensor comprises a first level sensor for indicating the low limit level and a second level sensor for indicating the intermediate level.

14. The steam cooking system of claim 12, wherein the controller is configured such that the power level of the heater is gradually increased until the at least one water level sensor indicates the water level in the tank has fallen to the low limit level.

15. A steam cooking system, comprising:
a steam cooking chamber;
a steam generator plumbed to deliver steam to the steam cooking chamber, the steam generator including:
a tank structure providing a heating chamber for holding water;
a heater associated with the tank structure for heating water within the heating chamber so as to generate steam;
at least one water level sensor associated with the tank;
a temperature sensor associated with the steam generator;
a fill line for selectively adding water to the tank;
a controller configured to control the heater, wherein the controller is configured to control a power level of the heater based upon both (i) a temperature indicated by the temperature sensor and (ii) a water level indicated by the at least one water level sensor, so as to increase steam generator temperature prior to water add.

16. The steam cooking system of claim 15, wherein the controller is configured to control the power level of the heater based upon the temperature indicated by the temperature sensor so as to maintain the temperature at a preset temperature level, until the water level indicated by the at least one water level sensor reaches a threshold low level, at which point the controller begins to increase the power level of the heater, without regard to the preset temperature level, while maintaining the power level below a full power level of the heater.

17. The steam cooking system of claim 14, wherein the preset temperature level is a temperature range.
